(19) United States
(12) Patent Application Publication
(10) Pub. No.: US 2026/0325389 A1
(43) Pub. Date: Oct. 22, 2026

(54) REAL-TIME SINGLE LEG GAIT TRAINING SYSTEM

(71) Applicant: The Chinese University of Hong Kong, Hong Kong (CN)

(72) Inventors: Kai Yu TONG, Hong Kong (CN); Yujie SU, Hong Kong (CN); Hsuan Yu LU, Hong Kong (CN); Zhongping YE, Hong Kong (CN); Kun ZHU, Hong Kong (CN); Choi Yin Cathy LAU, Hong Kong (CN)

(21) Appl. No.: 19/182,798

(22) Filed: Apr. 18, 2025

(51) Int. Cl. A61H 3/00

(52) U.S. Cl. CPC A61H 3/00; A61H 2003/007; A61H 2201/5061; A61H 2201/5071; A61H 2205/10

(57) ABSTRACT

A method and systems for single-leg gait training for a subject are provided. The method includes collecting real time data from an array of force sensors; performing modelling of maps of real-time gait cycle percentage-time of the subject's leg; activating and deactivating an assistive device based on time corresponding to fitted and predicted gait percentage in the modelling; performing real time gait evaluation of gait symmetry of the subject; and performing an assistive step. The performing modelling of maps of real-time gait cycle percentage-time of the subject's leg includes detecting gait events to separate gait phases; detecting transitioning between different gait events based on a state machine; mapping time into gait cycle percentages; fitting a curve for the gait cycle; and predicting next gait events and associated cycle percentage based on the fitted curve.

### BACKGROUND OF THE INVENTION

### 1. Field of the Disclosure

With the onset of an aging society, a growing number of individuals experience difficulties and pain while walking due to weakened muscles and joint issues. Consequently, there is increasing interest in walking assistance devices for those with muscle discomfort and difficulty walking. Additionally, walking assistance devices are being developed to enhance human strength for military applications.

Lower limb gait training is a rehabilitation method effectively using wearable devices for data recording and consistent assistance. The responsiveness of these devices is crucial, providing timely aid during movement and deactivating to minimize obstruction when not needed. Key challenges include delays between device output and control signals, significant for activating soft robotic systems, and irregular patient gait patterns, causing variation in assistance timing. In cases where patients with leg weakness use assistive devices, device impedance is critical. System delays can misalign assistance timing, affecting training efficacy. For example, if a pneumatic-powered device is meant to activate during the stance phase, starting with the heel strike detected by increased ground reaction force, latency in power assist actuation can misalign force application timing and intensity.

### BRIEF SUMMARY OF THE INVENTION

Embodiments of the subject invention pertain to a real-time single leg gait training method and systems.

According to an embodiment of the subject invention, a method for single-leg gait training for a subject is provided. The method comprises collecting real time data from an array of force sensors; performing modelling of maps of real-time gait cycle percentage-time of the subject's leg; activating and deactivating an assistive device based on time corresponding to fitted and predicted gait percentage in the modelling; performing real time gait evaluation of gait symmetry of the subject; and performing an assistive step. The performing modelling of maps of real-time gait cycle percentage-time of the subject's leg comprises detecting gait events to separate gait phases; detecting transitioning between different gait events based on a state machine; mapping time into gait cycle percentages; fitting a curve for the gait cycle; and predicting next gait events and associated cycle percentage based on the fitted curve. The gait events are configured to identify one of kinetic characteristics from motion information including an event in which one side of ground reaction force exceeds or falls below a threshold value; an event in which a center of pressure reaches a local maximum or maximum in lateral axis and/or anterior-posterior axis; and time characteristics demonstrating time exceeds predicted time of next gait event, with the predicted time being generated by averaging time for each gait event over one or a plurality of past gait events; performing a data fitting step; and predicting timing of the next gait event based on results of the data fitting step. The motion information includes ground reaction force and a center of pressure trajectory. The method may further comprise performing a post-correction step on gait events detected by predicted time by analyzing motion information, when subsequent gait event occurs, the occurrence time for the gait event is corrected based on kinetic characteristics. Moreover, the method may further comprise determining a continuous gait cycle percentage between gait events through gait event time mapping by performing linear interpolation of time and gait phase mapping. In addition, the method may further comprise anticipating gait cycle percentage and the corresponding occurrence time of next event as time characteristic for gait event detection. The method may further comprise performing gait training of the subject. The performing gait training is achieved by configuring the assistive device attached to one or more joints of an affected leg of the subject. Moreover, the performing gait training comprises applying assistance for duration of a specific phase of the gait cycle. The duration is determined based on required assistance, specifying start and end percentages of the gait cycle. The activating and deactivating occur at the mapped gait phase percentages. The performing gait training is implemented on a treadmill system, comprising a treadmill serving as a gait surface, with force sensors underneath to measure ground reaction force and subject movement throughout gait cycles to obtain kinetic information for determining gait phases; a display device mounted on the treadmill; an acquisition unit for collecting sensor information; and a controller for data processing and controlling. The performing real time gait evaluation comprises calculating gait spatial parameters, kinetic and/or kinematic parameters; clustering gait parameters of each cycle, based on gait events and cycle information from detection and prediction; and calculating a symmetry index to evaluate walking of an affected leg or an unaffected leg of the subject. The performing an assistive step includes configuring the assistive device for one or more of the joints of hip, knee, or ankle, providing gait training assistance during treadmill walking; and performing a walking assistance control to provide assistance and adjust an assistance level. The performing real time gait evaluation comprises calculating a center of pressure with the spatial parameters of the load cells; calculating torques to define a center of pressure applied location for the subject walking on a treadmill; calculating gait cycle parameters including cycle time, duration of stance and swing phases for an affected leg or an unaffected leg that are obtained from the center of pressure calculation; calculating step parameters including a step length, step width, and a step length ratio of the affected side and the unaffected side of the subject calculated from the center of pressure; and performing a center of pressure diagram analysis and in each gait cycle, calculating an intersection point of a diagram as a center of the center of pressure diagram, and calculating the distance between the center to left and to right of the center of pressure diagram, as indication of symmetry. The performing an assistive step further comprises measuring a body segment position and calculating a center of mass; measuring joint angles; measuring joint angular velocities; and measuring joint positions. The performing gait training of the subject comprises configuring features to automatically detect and separate gait phases, providing assistance to the target joint at specific time during the training, and upon providing assistance, calculating the symmetry index, and adjusting the assistance level accordingly to optimize the training. The performing gait training of the subject further comprises dividing gait parameters into cycles according to gait phases and calculating the symmetry index for each cycle, wherein a symmetry cost variable is determined by averaging the symmetry indices for all or selected parameters. The adjusting the assistance level is achieved by adjusting the assistance level from minimum to maximum based on the symmetrical cost variable to optimize training performance by improving the cost variable.

### BRIEF DESCRIPTION OF THE DRAWINGS

FIG. 1 is a schematic perspective view of a single-leg gait training system designed for a patient with unilateral paralysis, featuring a bilateral-belt treadmill and various sensor components, according to an embodiment of the subject invention.

FIG. 2 shows an illustrative application of the gait assistance device to multiple joints, including the hip, knee, and ankle, all integrated within the gait training system, according to an embodiment of the subject invention.

FIG. 3 is a detailed system configuration diagram showing the overall controller, treadmill driving unit, and communication interfaces within the gait training system, according to an embodiment of the subject invention.

FIG. 4 shows an example layout of the training monitor displaying key gait parameters, such as center of pressure, ground reaction force, joint angles, and gait events, according to an embodiment of the subject invention.

FIG. 5 is a process diagram of the gait detection and prediction method, highlighting the gait event detection, posterior correction, and event time prediction components, according to an embodiment of the subject invention.

FIG. 6 shows a complete gait cycle, illustrating the sequence of gait events and corresponding gait phases for both the target and contralateral legs, according to an embodiment of the subject invention.

FIGS. 7A-7B show kinetic information during the gait cycle, demonstrating ground reaction forces and center of pressure data correlated with each gait event, according to an embodiment of the subject invention.

FIG. 8 shows the simplest state machine model for gait event transitions, including states and transitions based on kinetic characteristics and timing, according to an embodiment of the subject invention.

FIG. 9 shows gait event state machine transitions determined by center of pressure characteristics, according to an embodiment of the subject invention.

FIG. 10 shows gait event state machine transitions determined by ground reaction force characteristics, according to an embodiment of the subject invention.

FIG. 11 shows breakdown of the gait cycle into eight phases from loading response to terminal swing, each defined by specific gait events, according to an embodiment of the subject invention.

FIG. 12 shows kinetic characteristics of the gait cycle as defined by the center of pressure.

FIG. 13 shows a state machine representing the eight-event gait cycle and their transitions, triggered by kinetic characteristics or time, according to an embodiment of the subject invention.

FIG. 14 shows results of the gait event detection and prediction, mapping detected events and the fitted gait cycle percentage-time curve, according to an embodiment of the subject invention.

FIG. 15 shows a gait event time prediction process, illustrating detected events, average event timings, and the fitted prediction curve, according to an embodiment of the subject invention.

FIGS. 16A-16D illustrate the fitting and prediction across several consecutive cycle, according to an embodiment of the subject invention.

FIG. 17 shows an implementation example of the assistance modulation unit for hip flexion assistance during the gait cycle, according to an embodiment of the subject invention.

FIGS. 18A-18D show an implementation example of the assistance modulation unit for knee extension assistance during the gait cycle, according to an embodiment of the subject invention.

FIG. 19A-19B show an example of the assistance modulation unit in operation for knee extension assistance, according to an embodiment of the subject invention.

FIG. 20 shows a gait evaluation module diagram, detailing the analysis of spatiotemporal, kinematic, and kinetic parameters, according to an embodiment of the subject invention.

FIG. 21 shows an assistance level optimization unit, showing the interaction with the gait evaluation module to adjust assistance levels, according to an embodiment of the subject invention.

FIG. 22 shows a user interface of the operation panel, providing controls for the treadmill and assistance device, and displaying gait parameter outputs, according to an embodiment of the subject invention.

FIG. 23 shows a display unit interface, presenting real-time treadmill speeds, center of pressure positions, joint angles, and live video feed of the subject's movement, according to an embodiment of the subject invention.

FIGS. 24A-24B show training outcomes from the gait training system, highlighting a comparison of joint motion angles via the embodiment display unit, according to an embodiment of the subject invention.

### DETAILED DISCLOSURE OF THE INVENTION

Embodiments of the subject invention are directed to a method and systems for single-leg gait training for a subject.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

A single-leg gait training system is provided, utilizing gait training platform such as a double-belt treadmill, where each belt can be independently controlled. The system includes sensors to capture motion data and employs a method for detecting and predicting gait events. Additionally, an evaluation method is offered to accurately assess gait pattern symmetry and adjust asymmetry by providing appropriate assistance.

According to the embodiments of the subject invention, a specialized gait training system for single-leg gait rehabilitation integrates components for advanced prediction to enhance the rehabilitation process. The system is built on a bilateral-belt treadmill, where each leg operates on a separate belt. The treadmill-based system may be equipped with force sensors and a camera for motion information capture, with force sensors positioned beneath the treadmill. The number of force sensors can vary, with a minimum requirement of four. Additionally, the system includes a data acquisition module to collect sensor and motion data, as well as a computation and control module to analyze the data.

In another embodiment, a robust gait event detection and prediction method is provided. determine the kinetic information of the gait pattern based on motion information from force sensors. In particular, each gait cycle is divided into several phases, separated by gait events. Transitions between these events are managed by a state machine, triggered by kinetic characteristics such as ground reaction forces or the center of pressure, as well as predicted occurrence times from the gait event and time mapping process. After detecting each gait event, the events and their corresponding times are averaged across multiple gait cycles and mapped into continuous time using a piecewise linear fitting technique. This mapping process enables the calculation of a continuous gait phase, enhancing the precision of assistance delivery throughout the gait cycle.

In the gait detection and prediction method described above, in one embodiment, the method is configured to divide each gait cycle into either 4 or 8 sub-phases, corresponding to 4 or 8 gait events. These events are aligned with the percentages of the gait cycle, and linear interpolation is applied to obtain a continuous gait phase corresponding to time. The division is determined by the required level of detail for gait phase segmentation.

Further, in the gait detection and prediction method described above, in one embodiment, the timing of gait events is determined based on the kinetic information and the predicted timing of the next event. The kinetic information may include ground reaction force or characteristics of the center of pressure trajectory. Specifically, if force sensors are installed beneath each single-belt treadmill, the ground reaction force for each side can be independently measured, allowing the ground reaction force from each side to serve as a kinetic characteristic for determining gait events. Alternatively, if separate measurements are not available, the trajectory of the center of pressure is configured to determine the timing of the gait event.

In the gait detection and prediction method described above, the method is configured to predict upcoming events based on the timing of gait events from one or several previous cycles. After detecting each new gait event, the timings across different cycles are averaged, and a fitting model—such as polynomial fitting, piecewise-linear fitting, or Gaussian fitting—is applied. This model can be applied to predict the timing of the next event. If the actual time exceeds the predicted time, the event is detected. Thus, the prediction method enables robust event detection, especially as the kinetic signals of gait events may be less significant in paralyzed subjects.

In another embodiment, the gait detection and prediction method discussed above and the gait evaluation method can be tailored for assessing the walking patterns of patients with leg paralysis. This method comprises acquiring kinematic and kinetic information including ground reaction forces and the location of each body segment, to calculate gait parameters for evaluating gait symmetry. These parameters are clustered in each cycle, based on the gait events and cycle information from the first aspect. Moreover, a symmetry index is calculated to evaluate the walking of the affected and unaffected legs.

The gait evaluation comprises calculating various gait parameters from sensor data. These parameters may include spatial parameters such as stride length, step length, stride width, cadence, and the ratio of different gait phases; kinematic parameters such as joint angles and angular velocities; and kinetic parameters, including the center of pressure trajectory and ground reaction force patterns. After obtaining the parameters, they are grouped into cycles based on the gait phase division from the first aspect and averaged accordingly. A symmetry index is calculated to assess the balance between the affected and unaffected legs by measuring their differences. Then, a symmetry cost variable is determined by averaging all the symmetry indices for all or selected parameters.

The gait evaluation method discussed above may also include a presentation unit designed to display information about the evaluated gait parameters, allowing the patient to review the information and assess the symmetry of their gait parameters and enabling them to adjust their walking pattern for improved balance and symmetry.

In another embodiment of the subject invention, a gait assistance device is attached to the affected leg and can be configured to one or more joints in hips, knees or ankles. The gait assistance device is controlled to facilitate the specified timing, according to the gait phases from the gait detection and prediction method, thus improving the walking symmetry and balance of the gait pattern, which may be indicated by the gait evaluation method.

Moreover, the gait assistance device is controlled to generate a desired assistance profile based on the real-time gait phase from the gait event detection and prediction results. To minimize impedance and compensate for the inherent time delay associated with the assistance device, the system is configured to predict the required assistive forces and deactivation timing in advance, enabling timely and precise interventions. For different joints, such as a device for hip flexion and another for knee extension, the activation and deactivation timings differ. Thus, the system is configured to allow unified control based on a single method by mapping the start and end times of assistance to specific gait phases.

The gait assistance device is configured to gradually adjust the assistance level based on symmetry. At low assistance levels, symmetry is lower because the affected side typically differs significantly from the unaffected side. As the assistance level increases, symmetry improves until it stabilizes and no longer increases with further assistance. The symmetry index, calculated in the second aspect, can be used to adjust the assistance level.

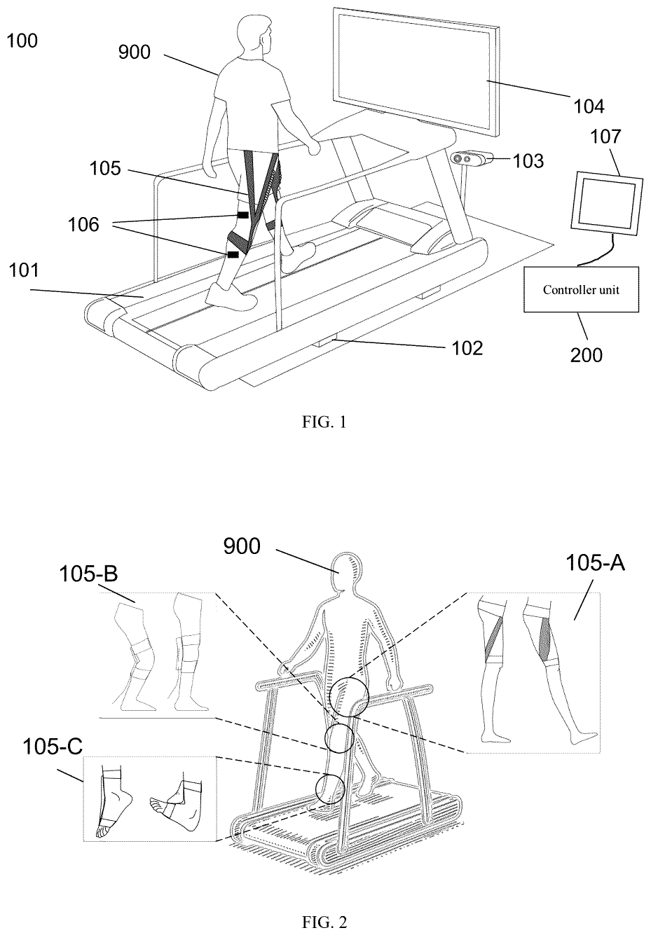

FIG. 1 is a schematic perspective view of a gait training system 100 according to the present embodiment. The gait training system 100 is a single-leg gait training system for the subject 900 who is suffering from paralysis in one leg and walking asymmetry. The system mainly includes a bilateral-belt treadmill, where each belt can be controlled independently, on which the trainee 900 walks, and force sensors matrix 102 are located underneath the treadmill. A gait assistance device 105 is attached to the affected leg, which is the paralyzed side of the trainee 900.

The controller unit 110 is part of the gait training system, serving as the overall controller for treadmill 101. The bilateral belt treadmill is driven by two motors independently, and the controller unit control the motors through motor drivers. It acquires information from the force sensor 102, camera 103 inertial measurement unit 106, controls the display unit 104 (such as a liquid crystal panel) to present the progress of training, gait parameters, and visual feedback of the subject 900's gait, and manages the assisting device 105.

Camera 103 is included as an imaging unit for observing the entire body of the subject 900. Installed near the training monitor 104, camera 103 includes a lens and imaging element with an angle of view for imaging the entire body of the subject 900, and it could further include a depth sensor for collecting body segment positions. The imaging element, such as a complementary metal oxide semiconductor (CMOS) image sensor, converts optical images into image signals.

The management monitor 104 is a display device that presents various menu items related to the training settings, parameter values during training, and training results. Additionally, the operation panel 107, connected to the controller, displays the training process and gait parameters. It also provides a user interface for the operator, such as the trainer, to input commands to control the treadmill and manage the training process.

The gait assistance device 105 is attached to the affected leg of the subject 900 and assists by extension and/or flexion force/torque on the joint during extension and flexion. Although FIG. 1 illustrates a knee walking assistance device configured on knee joint, this is merely an example. The walking assistance device 105 may support the entire lower body or specific portions, such as up to the knee or ankle, depending on the user's needs.

The force sensors 102 comprises a matrix of load sensors installed underneath the bilateral belt treadmill, which measure the magnitude and distribution of the forces applied to the sole of the subject 900. These sensors can be either single axis, measuring only the vertical force, or multi-axis, measuring both lateral and vertical forces. They can be placed across the entire treadmill or individually beneath each bilateral belt, resulting in two matrices. Each matrix contains at least four sensors to ensure accurate load detection.

The inertial measurement unit 106 can be used to measure the position of the leg. This unit measures the inclination, angular velocity, and angles of various parts relative to a fixed coordinate system. Although the diagram shows two units attached to the thighs, the inertial measurement unit can actually be used on both legs and can be installed on any area of interest.

FIG. 2 illustrates the potential application of the gait assistance device 105 to various joints. The gait assistance device 105 includes: 105-A, component designed for the hip joint, 105-B, component designed for the knee joint, and 105-C, component designed for the ankle joint. One or more of these components can be integrated into system 100. All components are controlled using the same control unit 110, ensuring coordinated assistance across the affected leg.

FIG. 3 is a system configuration diagram of the gait training system 100. The overall controller 200 is a processor, such as a personal computer, that controls the entire system. A treadmill driving unit 205 includes two motors driving the bilateral belt treadmill and two motor drivers. The overall controller 200 manages the rotation of each motor to control the speed of each side, calculating the rotation speed according to the walking speed and the belt ratio, and transmits a driving signal to the treadmill driving unit 205. The speeds can be the same or different, and the acceleration is modulated to prevent excessive acceleration or deceleration. Additionally, the motor control includes an emergency stop feature to ensure safety.

A Command Interface 201 receives input commands from the operator, through the user interface 107 and transmits the operation signals to the overall controller 200. The operator can instruct the system to turn the treadmill on or off, adjust the speed, start or stop training, input numerical values for settings, or select menu items via a user interface displayed on a control screen 107.

Display unit 206 in the overall controller 200 presents the information on a display screen 104, and/or the operation monitor 107. This information is presented in the form of graphs, real-time curves, and indices, displaying the progress of training, the treadmill's operational status, gait information, training duration, and a real-time video captured by the camera 103.

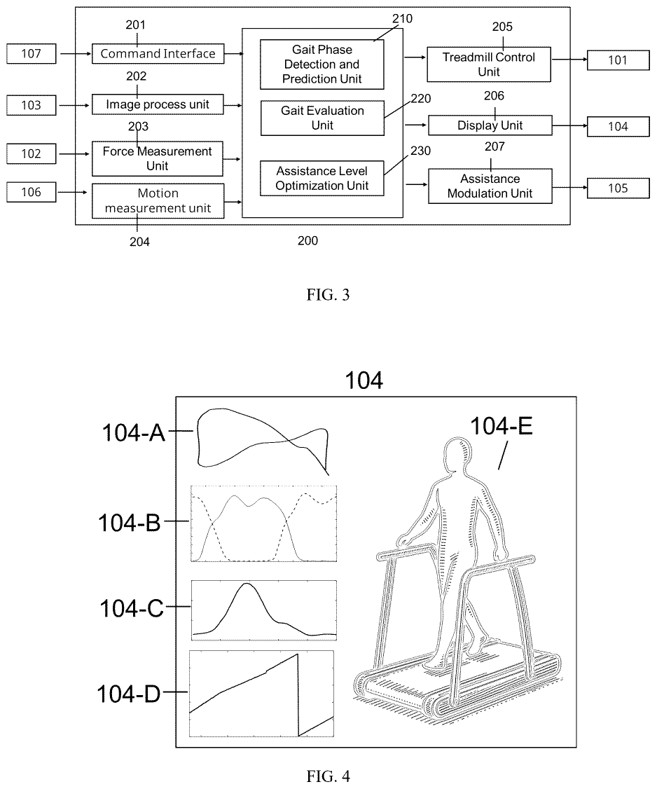

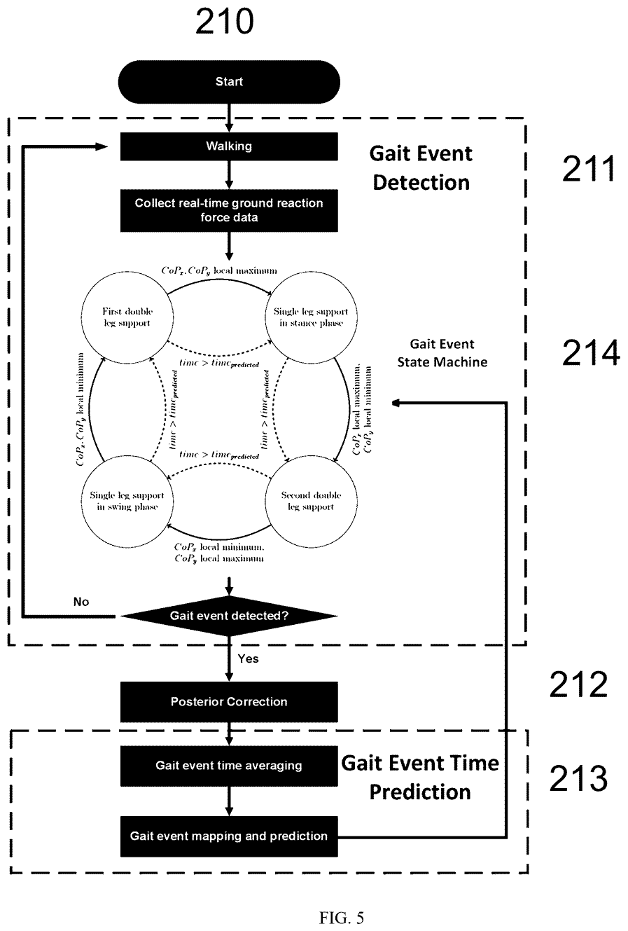

FIG. 4 illustrates an example of the training monitor 104, which includes several components: 104-A displays the center of pressure, 104-B shows the ground reaction force, 104-C presents joint angles, 104-D demonstrates the gait phase, and 104-E features real-time video captured by camera 103, showing the walking of subject 900.

The force measurement unit 203 within the overall controller 200 processes data from the force sensors 102. It calculates the resultant forces in various directions and determines the real-time center of pressure using torque balance methods.

The overall controller 200 includes image processor 202 that acquires images from the camera 103, processes them, and performs analysis. This includes detecting the position of body segments on a 2D graph through image segmentation. If an RGB-D camera is used, it can also capture depth information, process point clouds, and further determine the spatial positions of various joint areas.

The overall controller 200 includes motion measurement units 204 collecting information from IMUs 106, including angles, angular velocity, and angular acceleration. They calculate the angles between joints and other motion-related data.

The overall controller 200 also serves as a function execution unit, performing various control and calculation tasks. It includes a gait event detection and prediction unit 210 that processes kinetic information from the force measurement unit. This unit detects gait events based on kinetic characteristics or predicted timing, generating a gait policy for the subject 900 that maps different gait events to time. An assistance modulation unit 207, connected to the gait event and prediction units 210, providing assistance at appropriate phases. Additionally, a gait evaluation unit 220 processes information from the force measurement unit, image processing unit, motion measurement unit, and the gait detection and prediction unit. It calculates spatial, kinematic, and kinetic parameters of the subject, clustering them into each cycle and calculating a symmetry index. The assistance level optimization unit 230 adjusts the assistance level using data from the gait evaluation unit to improve symmetry. Specific processing details will be described later.

The gait assistance device 105 is attached to the affected leg of the subject 900. The system's overall controller 200 includes a component called the assistance modulation unit 105. This unit receives gait phase information from the gait event detection and prediction unit 210 and calculates the timing for assistance at each joint based on speed. For instance, it provides flexion assistance at the hip joint when the foot leaves the ground and stops after maximum flexion is achieved. The assistance modulation unit 207 uses this phase information and gait data to control when assistance is activated or deactivated. It also adjusts the level of assistance by increasing or decreasing the force or torque as needed, based on input from the assistance level optimization unit. Additionally, the modulation unit 207 manages the assistance device by controlling the opening and closing of valves or by starting and stopping motors. This precise control ensures that the device provides the right amount of support during different phases of the gait cycle, enhancing the effectiveness of the training.

FIG. 5 is a diagram outlining the procedure of the gait detection and prediction method 210. The method comprises the following components: gait Event detection 211, which involves segmenting the gait cycle and mapping it to a state machine 214 and utilizes force measurement data or predictive information to detect gait events accurately; posterior correction 212, that corrects the timing of the previously detected even after detecting each event and gait event time prediction 213 which includes averaging the gait event times, predicting future event times, and mapping these gait events and percentage to time.

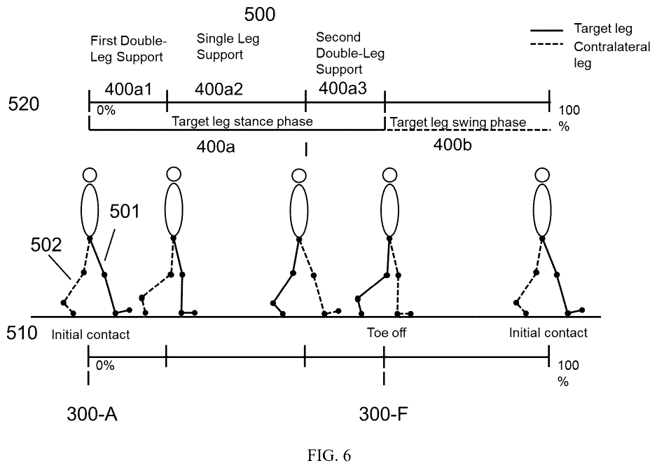

FIG. 6 is a diagram illustrating one gait cycle 500 with four gait events and two phases. For example, if the leg side is regarded as target (531), then the right should be the contralateral leg (532). A stride for the target leg (531) comprises the following key gait events (300) in sequence: Initial Contact (300-A) for target leg (531), Toe Off (B) for contralateral leg (532), Initial Contact (A) for contralateral leg (532), Toe Off (300-F) for target leg (531), and lastly Initial Contact (300-A) for target leg (531), which is the end of this cycle and also the start of the last cycle. These events define the gait phases (400): the Stance Phase (400a), when the foot is in contact with the ground from Initial Contact (300-A) to Toe Off (300-F), and the Swing Phase (400-b), when the foot is airborne from Toe Off (300-F) to Initial Contact (300-A). The Stance Phase (400-a) can further be divided based on the contralateral leg into First Double-Leg Support (400-a1), Single-Leg Support (400-a2), and Second Double-Leg Support (400-a3). Among these, Toe-Off and Initial Contact are identified as critical due to their significant roles in transitioning between phases and their unique kinetic properties.

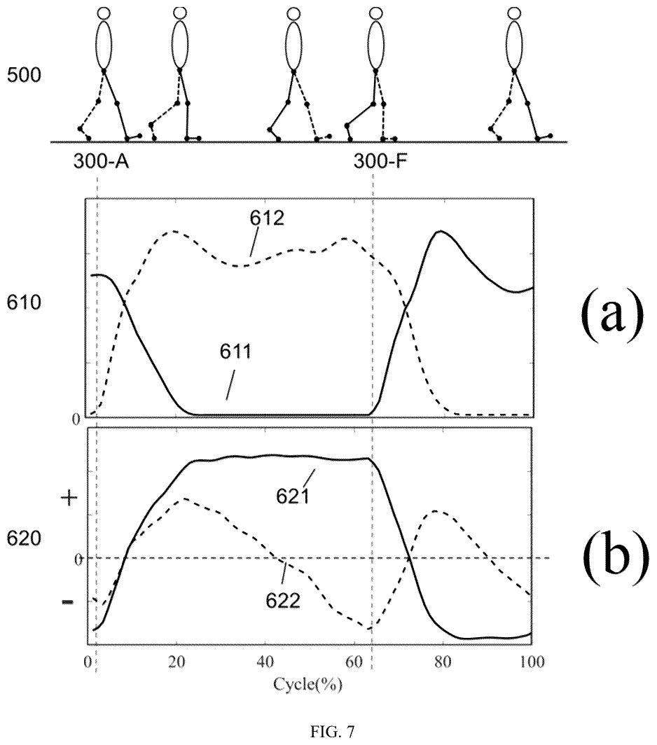

FIGS. 7A-7B are diagrams illustrating the four gait events in a gait cycle 500, showing the kinetic information for each leg, including the ground reaction force as shown in FIG. 7A and the center of pressure as shown in FIG. 7B. If force sensors 102 are installed under both belts of the bilateral treadmill, the ground reaction force can be calculated from the force measurement unit 203, providing both side ground reaction forces 611 and 612. The center of pressure shown in FIG. 7B includes the lateral position 621 and the anterior-posterior position 622. For Initial Contact (300-A), the corresponding side ground reaction force (611) shows an increasing trend, and the center of pressure shown in FIG. 7B reaches a minimum in both the lateral (621) and anterior-posterior (622) directions. For Toe Off (300-F), the ground reaction force (611) suddenly decreases, while the center of pressure shown in FIG. 7B reaches a local maximum in the lateral direction (621) and a minimum in the anterior-posterior direction (622).

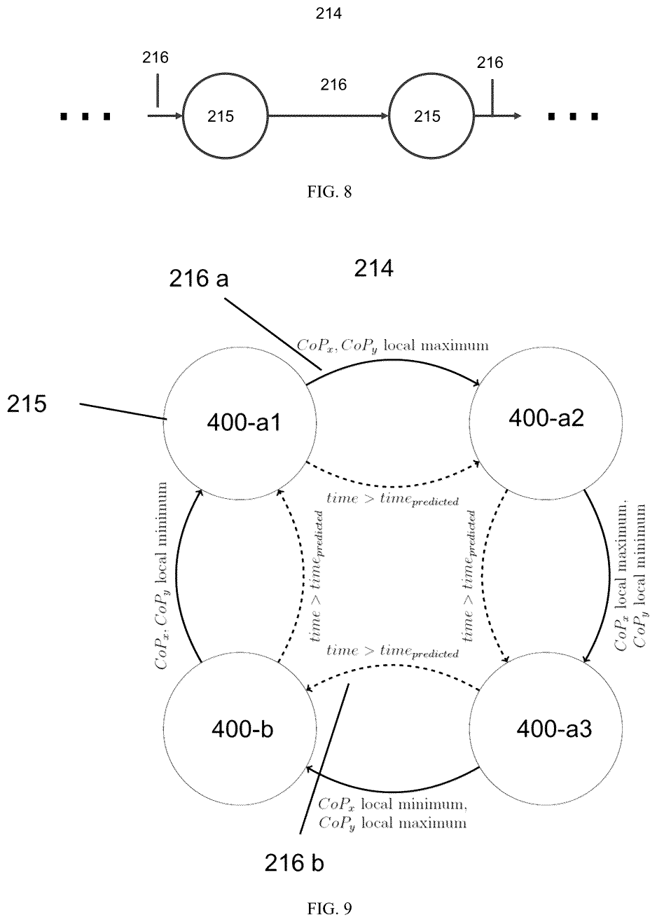

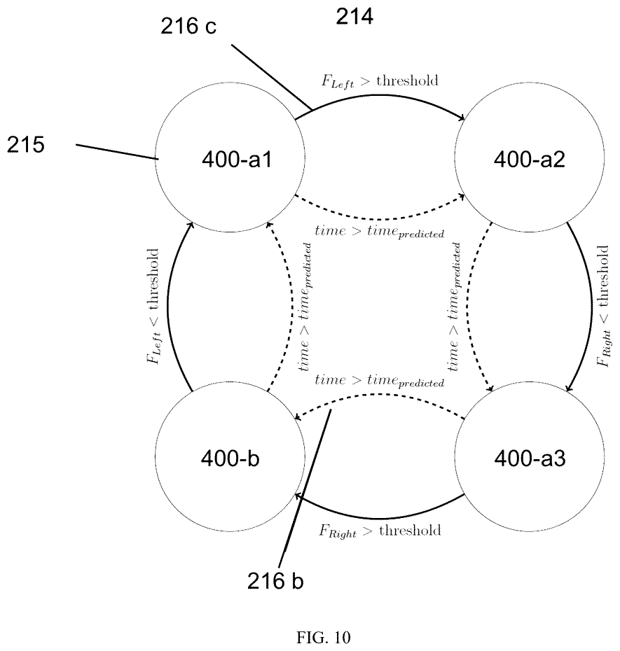

FIGS. 8, 9, and 10 showcase the state machine 214 of gait event transitions. FIG. 8 illustrates the simplest state machine model, including state 215 and transition 216. This framework manages different phases of the gait cycle, with state 215 indicating a specific phase and transition 216 representing the shift between phases. The sequence is modeled with four states, representing the four gait phases: 400 (a1, a2, a3, and b). Each phase corresponds to a state (215) in the state machine 214. These gait phases are separated by gait events (300A and 300F), corresponding to transitions (216) in the state machine. The transitions occur sequentially and must proceed in order, achieved by evaluating either kinetic characteristics (216a, 216c) or assessing time (216b). FIG. 9 illustrates transitions determined by the center of pressure shown in FIG. 7B, while FIG. 10 shows transitions determined by the ground reaction force of FIG. 7A.

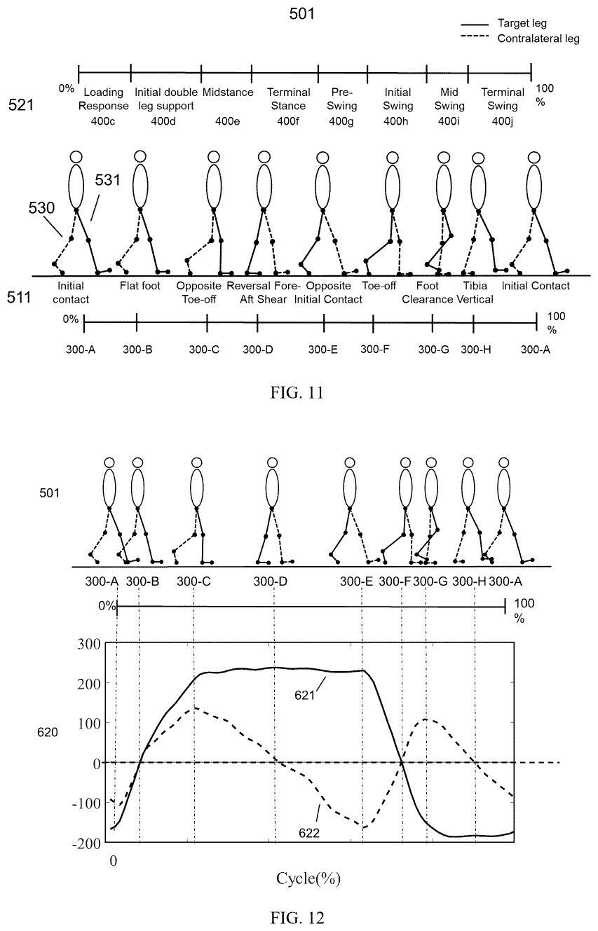

The gait cycle (501) can be divided into eight phases (521), separated by eight key gait events (511), as shown in FIG. 11. These events include: Initial Contact (300-A), where minimal force is applied as the foot first touches the ground; Flat Foot (300-B), where the foot becomes flat on the ground; Opposite Toe-Off (300-C), involving the toe-off of the contralateral leg; Reversal Fore-Aft Shear (300F), where shear forces transition; Opposite Initial Contact (300-D), where the opposite foot makes initial contact; Toe-Off (300-E), where the foot begins to leave the ground; Foot Clearance (300-F), featuring minimal kinetic activity as the foot clears the ground; and Tibia Vertical (300-H), where the tibia is vertical in preparation for the next initial contact. The gait cycle 501 is divided into eight phases 521: loading response 400c, initial double leg support 400d, midstance 400e, terminal stance 400f, pre-swing 400g, initial swing 400h, mid swing 400i, and terminal swing 400j.

FIG. 12 illustrates the kinetic characteristics of the gait cycle, distinguished through the center of pressure. The cycle comprises eight events: Initial Contact (300c), where the center of pressure reaches local minimal points in both lateral axis (621) and anterior-posterior axis (622); Flat Foot (300d), as it crosses the anterior-posterior axis (622); Opposite Toe-Off (300e), reaching local maximum points in both axes; Reversal Fore-Aft Shear (300f), crossing the zero point of the anterior-posterior axis (622); Opposite Initial Contact (300g), with a local maximum in the lateral axis (621) and a local minimum in the anterior-posterior axis (622). Following this, the Toe-Off phase (300h) occurs as the center of pressure crosses the anterior-posterior axis (622); Foot Clearance (300i) with a local maximum in the anterior-posterior axis (622) and a local minimum in the lateral axis (621); and finally, Tibia Vertical (300j), where it crosses the lateral axis (621).

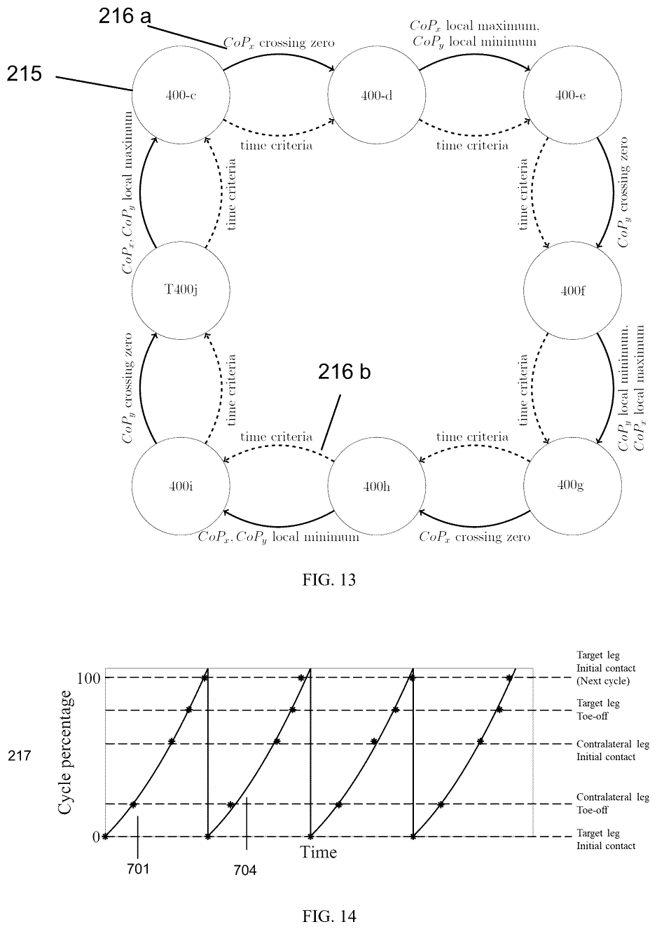

FIG. 13 illustrates the state machine demonstrating the eight-event gait cycle 501 and their transitions. This sequence is modeled as a state machine with eight states, representing the eight events: 300 (c to j). Each event corresponds to a state (215) in the state machine. The transition (216a) is triggered by specific characteristics of the center of pressure shown in FIG. 7B, and the transition (216b) is triggered by time exceeding the predicted time.

The gait detection and prediction method (200) is a real-time system that utilizes kinetic characteristics to identify gait events within a cycle. For patients with impairments, who may experience asymmetric and unstable gaits, detecting these characteristics can be challenging. To address this, the method includes a time prediction component, which involves gait event time fitting and mapping these events to time using a fitted model.

FIG. 14 illustrates the result of the gait event and prediction 200, which showcasing two main elements: the detected gait events 701 and the fitted gait cycle percentage-time curve, 704. Gait events are mapped to general percentage points within the gait cycle. For example, the initial contact (300A for 530) is defined as 0%, the contralateral leg toe-off (300F for 531) as 10%, the contralateral leg initial contact as 60% (300A for 531), and the target leg toe-off as 70% (300F for 530). However, this mapping is just conventional and not mandatory; any increasing sequence can be used.

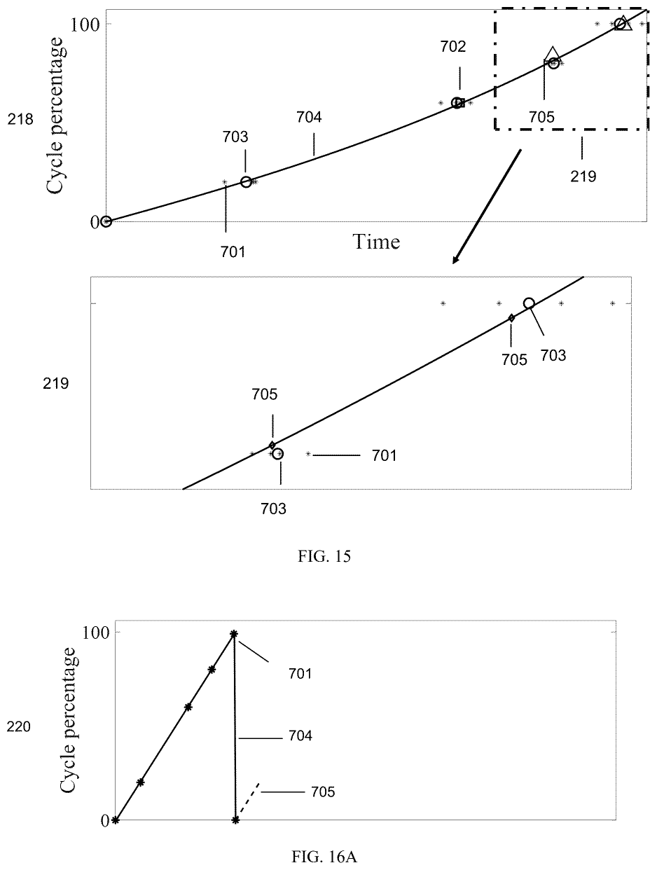

FIG. 15 illustrates the process of gait event time prediction 213, presenting the gait evets 701, average events 703 and the fitted curve 704, in one cycle 218. After detecting an event, the system averages the timings of past events (701) over one or several cycles. For instance, if the current event (702) is toe-off (300A for 531), the system normalizes the gait events 701 and their corresponding times into one cycle and averages them. A mathematical model, such as polynomial fitting, is then used to fit the percentage of gait time to the average timing of events across cycles. Once the model is fitted, it is used to predict the next event. By inputting the current time into the model 704, the system can calculate the corresponding gait percentage. The predicted timing 705 of event serves as a threshold; if the actual time surpasses this threshold, the system detects the next gait event and transitions to the corresponding state, as 216b. 219 is an enlarged view of the predicted state 705 in 218.

The gait detection and prediction method (200) include a posterior correction mechanism 212. After each gait event is detected—whether through kinetic information or predicted detection—the system analyzes kinetic data from the completed cycle to recalibrate the timing of the previous event. Each time the model makes predictions, it uses the corrected timing to ensure accuracy.

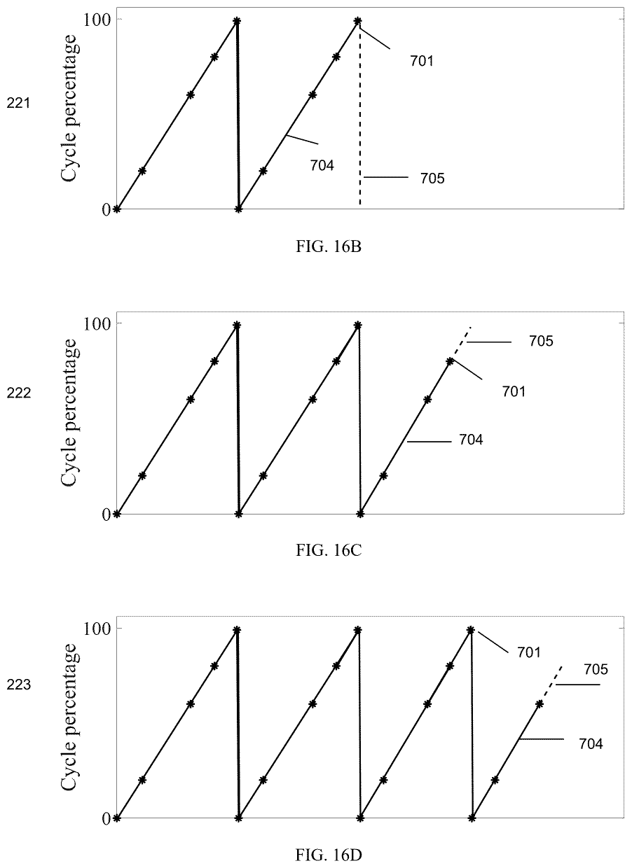

FIGS. 16A-16D illustrate the fitting and prediction across several consecutive cycles. Specifically, FIG. 16A showcases the first cycle, FIG. 16B displays the second cycle, FIG. 16C presents the third cycle, and FIG. 16D exhibits the fourth cycle. In the method, a minimum of one complete cycle is required to initiate predictions. Thus, FIG. 16A demonstrates the fitting curve 704 derived from the data of event 701 in the first cycle to predict the percentage 705 at the onset of the next event, and this process continues iteratively. Across these four cycles, the lengths of the periods vary. The cycle time in 220 and 221 are 1.2 second, and the cycle in 222 and 223 are 1.1 second. This outcome demonstrates the method's capability to adapt to changing cycle durations, highlighting its flexibility and adaptability.

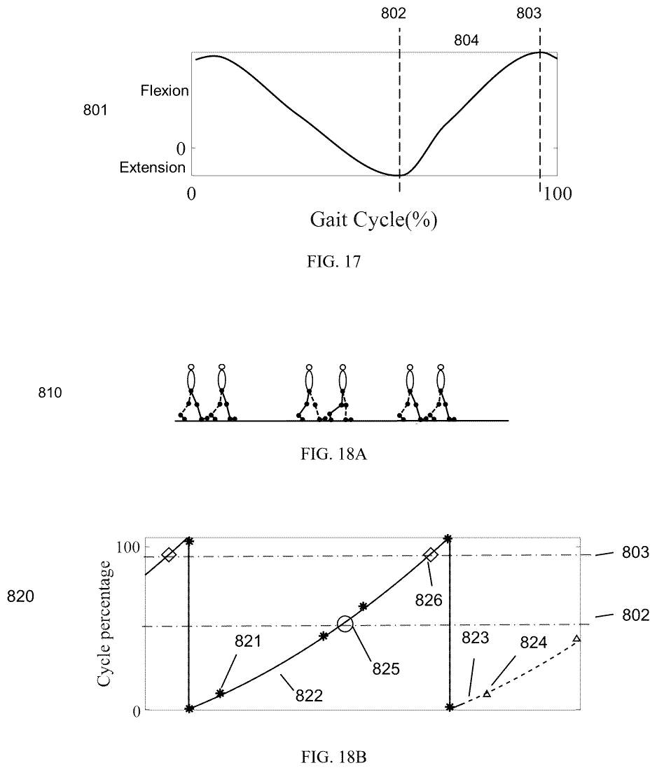

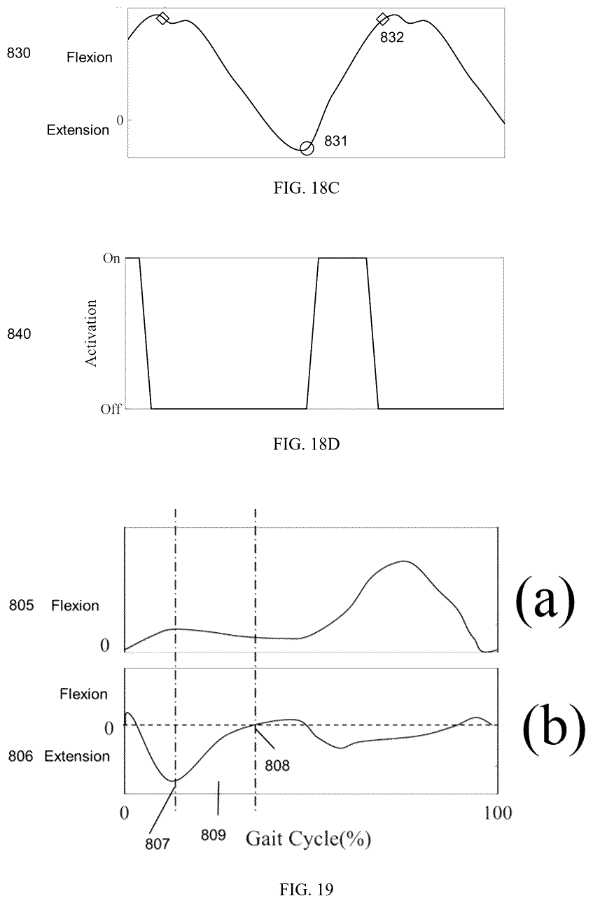

FIG. 17 and FIGS. 18A-18D illustrate an embodiment of the implementation assistance modulation unit 207. This instance is used for hip flexion assistance. FIG. 17 depicts the hip joint angle within a cycle, where values greater than 0 indicate flexion and values less than 0 indicate extension. To achieve hip joint assistance, it is necessary to activate assistance at the start of flexion time point 802 (60% of the gait cycle) and deactivate it after reaching peak 803 (95% of the gait cycle). Therefore, the required assistance gait percentage is 804. According to the relationship shown in FIG. 17, the assistance modulation unit 207 receives the gait percentage information from gait event time prediction 213. During the motion process as shown in FIG. 18A, the gait training system captures the subject's gait cycle percentage along time as shown in FIG. 18C, using the gait event detection and prediction method 200 based on force measurements 203. At the time point corresponding to percent 825 of the gait cycle, assistance is initiated, and at the time point corresponding to percent 826, assistance is terminated. FIG. 18C shows the actual hip joint angle during motion, with 831 indicating the joint angle at the onset of assistance and 832 at its termination. So, the assistance modulation unit 207 would be active in the assistance during the process, so shown in FIG. 18D. The hip joint angle characteristic curve FIG. 17 is merely an example and can correspond to any feature, including EMG characteristics or dynamic features such as joint torque.

FIGS. 19A-19B illustrate an embodiment of the implementation assistance modulation unit 207, in which the assistance device is used for knee extension assistance. FIG. 19A depicts the knee joint angle within a cycle and FIG. 19B depicts the knee joint moment within a cycle, where values greater than 0 indicate flexion moment and values less than 0 indicate extension moment. To achieve knee joint extension assistance, it is necessary to activate assistance at the start of extension time point 807 (60% of the gait cycle) and deactivate it after the extension moment reaches zero, at time point 808. Hence, the cycle period 809 represents the assistance period in this embodiment.

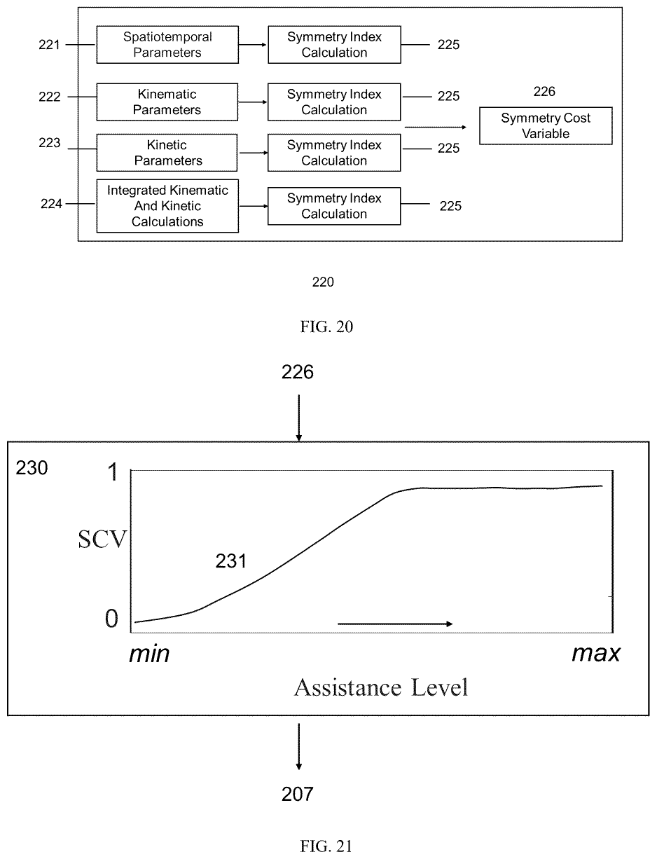

The system includes a gait evaluation module (220), as illustrated in FIG. 20 that gathers information from various sensors to analyze the gait data of subject 900. This analysis encompasses several components. First, it examines spatiotemporal parameters (221), which includes step length, step width, stride length, and the ratio of different gait phases. It also performs kinematic parameters (222) by utilizing an RGB-D camera and/or inertial measurement units to capture real-time skeletal points and joint positions, calculating joint angles throughout the gait cycle. and Kinetic parameters (223) include the calculation of the Center of Pressure (COP) and ground reaction force. Additionally, the system performs integrated kinematic and kinetic calculations (224) by using segment positions and ground reaction forces to determine the COM-COP Vector and Inclination Angles (IA), with data clustered into cycles via the gait phase detection and prediction unit. Finally, the symmetry index calculation (225) compares relative values between the affected and non-affected sides, with a symmetry cost variable (226) summing these indices for an overall evaluation.

The system includes an assistance level optimization unit 230, as shown in FIG. 21 The optimization unit 230 receives information from the gait evaluation module 220, specifically the symmetry cost variable (SCV) 226, to adjust the assistance level based on symmetry. The assistance modulation unit 207 begins with a low assistance level. The assistance level optimization unit 230 evaluates the symmetry cost variable 226, increasing the assistance level if the symmetry cost is small, until no further improvement is observed, as shown in the assistance level and SCV curve 231. This process continuously adjusts the assistance level of unit 207.

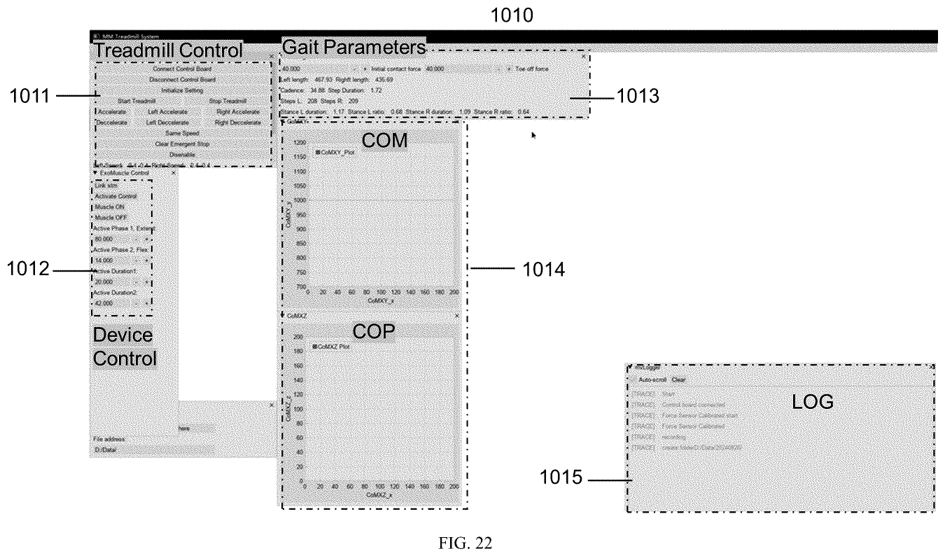

FIG. 22 depicts an embodiment of the operation panel 107 displaying the user interface. The user interface 1010 includes the following components: 1011, treadmill control buttons, which can start and stop the treadmill, control the speed of each belt independently, and adjust the acceleration; 1012, assistance device control buttons, which allow for the activation and deactivation of assistance, selection of the affected side (left or right), adjustment of control parameters, assistance start time, and duration of assistance; 1013, gait parameter output, displaying spatial parameters acquired by the gait evaluation module (220); 1014, kinetic parameters calculated by the gait evaluation module (220); 1015, log output, showing significant events.

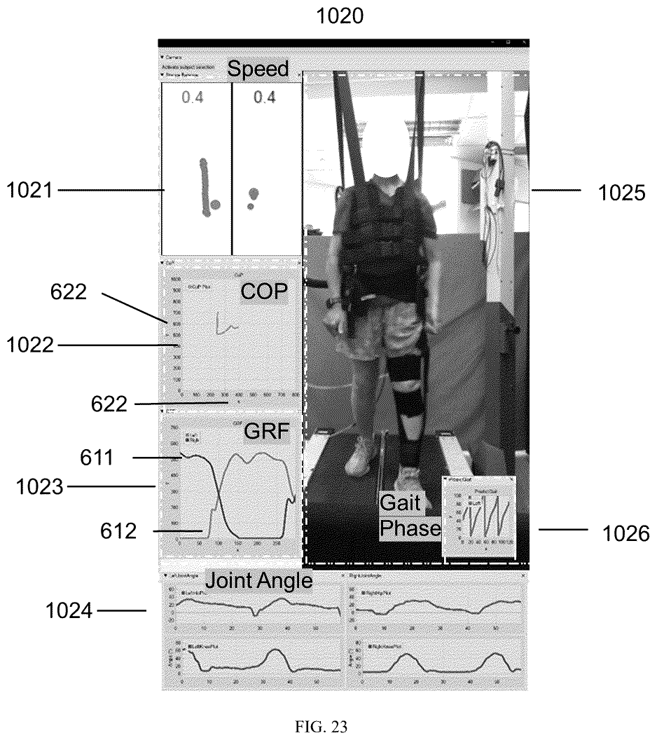

FIG. 23 illustrates an embodiment of the display unit 104, with the user interface 1020 containing a display of the speeds of both treadmill belts and the position of the center of pressure on the treadmill belts. It also shows the center of pressure trajectory calculated by the gait evaluation unit 220, the bilateral ground reaction force calculated by the same unit, and the joint angles derived from the gait evaluation calculations. Furthermore, the interface features a real-time video feed of the subject 900's movement, captured by camera 103, as well as real-time gait percentage information computed by the gait detection and prediction unit 210.

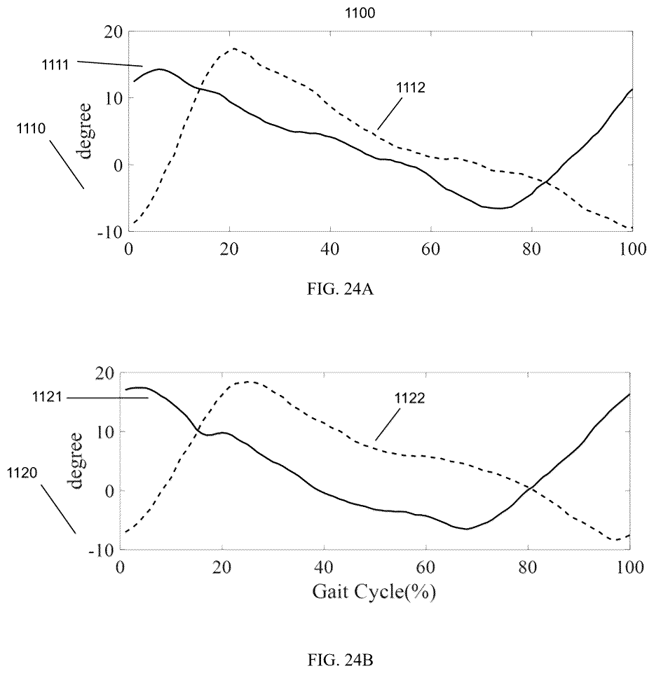

FIGS. 24A-24B illustrates the training outcomes from the gait training system and training setup, shown in FIG. 16 and FIG. 17., illustrating a comparison of joint motion angles using embodiment display unit 104. The figures show pre- and post-training sagittal plane hip joint angles. FIG. 24A displays the pre-training angles where 1111 represents the affected side with a motion range of 20.85 degrees, and 1112 represents the non-affected side with a motion range of 26.85 degrees, yielding a symmetry index of 0.7765. The post-training angles are shown in FIG. 24B, where 1121 represents the affected side with a motion range of 23.95 degrees, and 1122 represents the non-affected side with a motion range of 26.79 degrees. It is evident that 1121 shows an increased range of motion compared to 1111, while 1122 remains comparable to 1112, indicating that the training system effectively enhances the range of motion on the affected side.

The post-training symmetry index is calculated to be 0.8940, demonstrating an improvement in motion symmetry.

### Gait Parameters Calculation

### COP Calculation

When calculating the Center of Pressure (COP), data from four uni-axial vertical force sensors placed at each corner of the treadmill is utilized. Each sensor, equipped with a strain gauge, converts applied force into voltage for computer data collection. The COP is calculated as follows:

$${CoP}_{x} = \frac{{\sum }_{i}^{N} {F}_{i} \cdot {x}_{i}}{{\sum }_{i}^{N} {F}_{i}}$$

$${CoP}_{y} = \frac{{\sum }_{i}^{N} {F}_{i} \cdot {y}_{i}}{{\sum }_{i}^{N} {F}_{i}}$$

Where Fᵢ represents the force value measured by each sensor, xᵢ denotes the x-coordinate position of each sensor and yᵢ denotes the y-coordinate position of each sensor. These are used to calculate the center of pressure exerted on multiple sensors. N represents the number of sensors. The calculation of the center of pressure (COP) does not depend on N, and it can be computed using 4, 6, or 8 sensors.

### COM-COP Vector: Inclination Angles (IA)

The inclination angle (IA) of the COM-COP vector in the sagittal and frontal planes would be calculated as follows:

$$\vec{I} = ( \vec{Z} \times \frac{{\vec{P}}_{COM - COP}}{\vert {\vec{P}}_{COM - COP} \vert} ) Saggial IA = {sin}^{- 1} {\vec{I}}_{Y} Frontal IA = \{ \begin{matrix}- {sin}^{- 1} {\vec{I}}_{X} , for the right limb \\ {sin}^{- 1} {\vec{I}}_{X} for the left limb\end{matrix}$$

where [symbol] _{COM-COP} is the vector pointing from the COP to the COM, [symbol] is the vertical unit vector, and [symbol] is the unit vector pointing in the direction of progression. The rate of change of IA (RCIA) would be calculated by differentiating the IA trajectories using GCVSPL method.

### Symmetry Index Calculation:

Symmetry index is to calculate the absolute difference between the parameters of the affected leg and the nonaffected leg and divided by the summation of them. P_{affect} refers to the gait parameters of the affected side and P_{non affect} refers to the gait parameter of the non-affect side.

$$SI = \frac{\vert {P}_{non affect} - {P}_{affect} \vert}{{P}_{non affect} + {P}_{non affect}}$$

An example of SI on using step length: if right side is the affected side with a step length (0.4 m) shortener than left side which is the unaffected side having a normal step length (0.5 m), then the SI is 0.11. If the value of SI=0, then both sides are symmetric.

### Symmetry Cost Variable Calculation:

Symmetry cost variable calculation is calculated by averaging all related symmetry index of different parameters.

$$SCV = \frac{{\sum }_{k = 1}^{n} {SI}_{k}}{n}$$

where n is the numbers of the interested.

A single-leg gait training system is configured for detection and prediction of gait events, gait evaluation, and adaptive assistance profiles tailored for varying speeds and gait patterns. Kinematic and kinetic motion data are measured for detection of gait events, and the timing of upcoming events is predicted in advance. The assistance profile is adjusted according to the latency of the assistive device and the walking pattern, ensuring assistance is provided precisely when needed. Furthermore, the symmetry of gait parameters is evaluated and used as a cost variable to optimize the assistance profile.

### Exemplary Embodiments

Embodiment 1. A method for single-leg gait training for a subject, comprising:
collecting real time data from an array of force sensors;
performing modelling of maps of real-time gait cycle percentage-time of the subject's leg;
activating and deactivating an assistive device based on time corresponding to fitted and predicted gait percentage in the modelling;
performing real time gait evaluation of gait symmetry of the subject; and
performing an assistive step.

Embodiment 2. The method of embodiment 1, wherein the performing modelling of maps of real-time gait cycle percentage-time of the subject's leg comprises:
detecting gait events to separate gait phases;
detecting transitioning between different gait events based on a state machine;
mapping time into gait cycle percentages;
fitting a curve for the gait cycle; and
predicting next gait events and associated cycle percentage based on the fitted curve.

Embodiment 3. The method of embodiment 2, wherein the gait events are configured to identify one of kinetic characteristics from motion information including:
an event in which one side of ground reaction force exceeds or falls below a threshold value;
an event in which a center of pressure reaches a local maximum or maximum in lateral axis and/or anterior-posterior axis; and
time characteristics demonstrating time exceeds predicted time of next gait event, with the predicted time being generated by:
averaging time for each gait event over one or a plurality of past gait events;
performing a data fitting step; and
predicting timing of the next gait event based on results of the data fitting step.

Embodiment 4. The method of embodiment 3, wherein the motion information includes ground reaction force and a center of pressure trajectory.

Embodiment 5. The method of any preceding embodiment, further comprising performing a post-correction step on gait events detected by predicted time by analyzing motion information, when subsequent gait event occurs, the occurrence time for the gait event is corrected based on kinetic characteristics.

Embodiment 6. The method of any preceding embodiment, further comprising determining a continuous gait cycle percentage between gait events through gait event time mapping by performing linear interpolation of time and gait phase mapping.

Embodiment 7. The method of any preceding embodiment, further comprising anticipating gait cycle percentage and the corresponding occurrence time of next event as time characteristic for gait event detection.

Embodiment 8. The method of any preceding embodiment, further comprising performing gait training of the subject.

Embodiment 9. The method of any preceding embodiment, wherein the performing gait training is achieved by configuring the assistive device attached to one or more joints of an affected leg of the subject.

Embodiment 10. The method of any preceding embodiment, wherein the performing gait training comprises applying assistance for duration of a specific phase of the gait cycle.

Embodiment 11. The method of any preceding embodiment, wherein the duration is determined based on required assistance, specifying start and end percentages of the gait cycle.

Embodiment 12. The method of any preceding embodiment, wherein the activating and deactivating occur at the mapped gait phase percentages.

Embodiment 13. The method of any preceding embodiment, wherein the performing gait training is implemented on a treadmill system, comprising:
a treadmill serving as a gait surface, with force sensors underneath to measure ground reaction force and subject movement throughout gait cycles to obtain kinetic information for determining gait phases;
a display device mounted on the treadmill;
an acquisition unit for collecting sensor information; and
a controller for data processing and controlling.

Embodiment 14. The method of any preceding embodiment, wherein the performing real time gait evaluation comprises:
calculating gait spatial parameters, kinetic and/or kinematic parameters;
clustering gait parameters of each cycle, based on gait events and cycle information from detection and prediction; and
calculating a symmetry index to evaluate walking of an affected leg or an unaffected leg of the subject.

Embodiment 15. The method of any preceding embodiment, wherein the performing an assistive step includes:
configuring the assistive device for one or more of the joints of hip, knee, or ankle, providing gait training assistance during treadmill walking; and
performing a walking assistance control to provide assistance and adjust an assistance level.

Embodiment 16. The method of any preceding embodiment, wherein the performing real time gait evaluation comprises:
calculating a center of pressure with the spatial parameters of the load cells;
calculating torques to define a center of pressure applied location for the subject walking on a treadmill;
calculating gait cycle parameters including cycle time, duration of stance and swing phases for an affected leg or an unaffected leg that are obtained from the center of pressure calculation;
calculating step parameters including a step length, step width, and a step length ratio of the affected side and the unaffected side of the subject calculated from the center of pressure; and
performing a center of pressure diagram analysis and in each gait cycle, calculating an intersection point of a diagram as a center of the center of pressure diagram, and calculating the distance between the center to left and to right of the center of pressure diagram, as indication of symmetry.

Embodiment 17. The method of any preceding embodiment, wherein the performing an assistive step further comprises:
measuring a body segment position and calculating a center of mass;
measuring joint angles;
measuring joint angular velocities; and
measuring joint positions.

Embodiment 18. The method of any preceding embodiment, wherein the performing gait training of the subject comprises configuring features to automatically detect and separate gait phases, providing assistance to the target joint at specific time during the training, and upon providing assistance, calculating the symmetry index, and adjusting the assistance level accordingly to optimize the training.

Embodiment 19. The method of any preceding embodiment, wherein the performing gait training of the subject further comprises dividing gait parameters into cycles according to gait phases and calculating the symmetry index for each cycle, wherein a symmetry cost variable is determined by averaging the symmetry indices for all or selected parameters.

Embodiment 20. The method of any preceding embodiment, wherein the adjusting the assistance level is achieved by adjusting the assistance level from minimum to maximum based on the symmetrical cost variable to optimize training performance by improving the cost variable.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A method for single-leg gait training for a subject, comprising:
collecting real time data from an array of force sensors;
performing modelling of maps of real-time gait cycle percentage-time of the subject's leg;
activating and deactivating an assistive device based on time corresponding to fitted and predicted gait percentage in the modelling;
performing real time gait evaluation of gait symmetry of the subject; and
performing an assistive step.

2. The method of claim 1, wherein the performing modelling of maps of real-time gait cycle percentage-time of the subject's leg comprises:
detecting gait events to separate gait phases;
detecting transitioning between different gait events based on a state machine;
mapping time into gait cycle percentages;
fitting a curve for the gait cycle; and
predicting next gait events and associated cycle percentage based on the fitted curve.

3. The method of claim 2, wherein the gait events are configured to identify one of kinetic characteristics from motion information including:
an event in which one side of ground reaction force exceeds or falls below a threshold value;
an event in which a center of pressure reaches a local maximum or maximum in lateral axis and/or anterior-posterior axis; and
time characteristics demonstrating time exceeds predicted time of next gait event, with the predicted time being generated by:
averaging time for each gait event over one or a plurality of past gait events;
performing a data fitting step; and
predicting timing of the next gait event based on results of the data fitting step.

4. The method of claim 3, wherein the motion information includes ground reaction force and a center of pressure trajectory.

5. The method of claim 1, further comprising performing a post-correction step on gait events detected by predicted time by analyzing motion information, when subsequent gait event occurs, the occurrence time for the gait event is corrected based on kinetic characteristics.

6. The method of claim 1, further comprising determining a continuous gait cycle percentage between gait events through gait event time mapping by performing linear interpolation of time and gait phase mapping.

7. The method of claim 1, further comprising anticipating gait cycle percentage and the corresponding occurrence time of next event as time characteristic for gait event detection.

8. The method of claim 1, further comprising performing gait training of the subject.

9. The method of claim 8, wherein the performing gait training is achieved by configuring the assistive device attached to one or more joints of an affected leg of the subject.

10. The method of claim 9, wherein the performing gait training comprising applying assistance for duration of a specific phase of the gait cycle.

11. The method of claim 10, wherein the duration is determined based on required assistance, specifying start and end percentages of the gait cycle.

12. The method of claim 1, wherein the activating and deactivating occur at the mapped gait phase percentages.

13. The method of claim 1, wherein the performing gait training is implemented on a treadmill system, comprising:
a treadmill serving as a gait surface, with force sensors underneath to measure ground reaction force and subject movement throughout gait cycles to obtain kinetic information for determining gait phases;
a display device mounted on the treadmill;
an acquisition unit for collecting sensor information; and
a controller for data processing and controlling.

14. The method of claim 1, wherein the performing real time gait evaluation comprises:
calculating gait spatial parameters, kinetic and/or kinematic parameters;
clustering gait parameters of each cycle, based on gait events and cycle information from detection and prediction; and
calculating a symmetry index to evaluate walking of an affected leg or an unaffected leg of the subject.

15. The method of claim 1, wherein the performing an assistive step includes:
configuring the assistive device for one or more of the joints of hip, knee, or ankle, providing gait training assistance during treadmill walking; and
performing a walking assistance control to provide assistance and adjust an assistance level.

16. The method of claim 1, wherein the performing real time gait evaluation comprises:
calculating a center of pressure with the spatial parameters of the load cells;
calculating torques to define a center of pressure applied location for the subject walking on a treadmill;
calculating gait cycle parameters including cycle time, duration of stance and swing phases for an affected leg or an unaffected leg that are obtained from the center of pressure calculation;
calculating step parameters including a step length, step width, and a step length ratio of the affected side and the unaffected side of the subject calculated from the center of pressure; and
performing a center of pressure diagram analysis and in each gait cycle, calculating an intersection point of a diagram as a center of the center of pressure diagram, and calculating the distance between the center to left and to right of the center of pressure diagram, as indication of symmetry.

17. The method of claim 15, wherein the performing an assistive step further comprises:
measuring a body segment position and calculating a center of mass;
measuring joint angles;
measuring joint angular velocities; and
measuring joint positions.

18. The method of claim 8, wherein the performing gait training of the subject comprises configuring features to automatically detect and separate gait phases, providing assistance to the target joint at specific time during the training, and upon providing assistance, calculating the symmetry index, and adjusting the assistance level accordingly to optimize the training.

19. The method of claim 18, wherein the performing gait training of the subject further comprises dividing gait parameters into cycles according to gait phases and calculating the symmetry index for each cycle, wherein a symmetry cost variable is determined by averaging the symmetry indices for all or selected parameters.

20. The method of claim 19, wherein the adjusting the assistance level is achieved by adjusting the assistance level from minimum to maximum based on the symmetrical cost variable to optimize training performance by improving the cost variable.
